(19) United States
(12) Patent Application Publication
(10) Pub. No.: US 2008/0228845 A1
(43) Pub. Date: Sep. 18, 2008

(54) APPARATUS FOR CALCULATING AN N-POINT DISCRETE FOURIER TRANSFORM BY UTILIZING COOLEY-TUKEY ALGORITHM

(75) Inventor: CHING-HSIEN CHANG, Chunan Town (TW)

Correspondence Address: HOLLAND & KNIGHT LLP, 10 ST. JAMES AVENUE, 11th Floor, BOSTON, MA, 02116-3889, US

(73) Assignee: Accfast Technology Corp., Hsinchu (TW)

(21) Appl. No.: 11/931,077

(22) Filed: Oct. 31, 2007

(30) Foreign Application Priority Data
Mar. 13, 2007 (TW) 096108608

(51) Int. Cl. G06F 17/14

(52) U.S. Cl. 708/405

(57) ABSTRACT

An apparatus for calculating an N-point Discrete Fourier Transforms (DFTs) and/or Inverse DFTs (IDFTs) using the Cooley-Tukey algorithm is provided. The N-point DFT/IDFT is achieved by calculating a plurality of N₁-point and N₂-point DFTs. The apparatus comprises a storing unit, a calculating unit, and a controlling unit. The storing unit comprises a first memory for storing a plurality of first data and a second memory for storing a plurality of second data. The calculating unit comprises a one-dimensional systolic array for calculating the N₁-point and N₂-point DFT.

### RELATED APPLICATION

This application claims the benefit of priority of Taiwan Patent Application No. 096108608, filed on 13 Mar. 2007, the disclosure of which is incorporated herein by reference in its entirety.

### BACKGROUND OF THE INVENTION

1. Field of the Invention

The present invention relates to an apparatus for calculating an N-point Discrete Fourier Transform (DFT). Specifically, the present invention relates to an apparatus for calculating an N-point DFT by utilizing the Cooley-Tukey algorithm.

2. Descriptions of the Related Art

The Discrete Fourier Transform (DFT) and the Inverse Discrete Fourier Transform (IDFT) are two important transformations in the field of digital signal processing.

In many applications, long-length DFTs/IDFTs often occur. For example, the ANSI T1.413 Asymmetric Digital Subscriber Line (ADSL) has to calculate 512-point DFTs/IDFTs. Furthermore, the Orthogonal Frequency Division Multiplexing, adopted in the European Digital Audio Broadcasting (DAB) standard, requires calculations of long-length DFTs/IDFTs. In addition, DFTs and IDFTs play important roles in audio signal processing, spectrum analyses, pattern recognitions, data compressions, convolution computations, optical images, and frequency adaptations. Consequently, it is important to know how to use a single chip to calculate a long-length DFT/IDFT within a small amount of time.

Currently, many researchers have provided algorithms and hardware structures to fast calculate the DFTs. For example, in the article “Efficient VLSI architectures for fast computation of the discrete Fourier transform and its inverse,” by C.-H. Chang, C.-L. Wang, and Y.-T. Chang, IEEE Trans. Signals Processing, vol. 48, pp. 3206-3216, November 2000, an apparatus that calculates the DFT is provided. Although some of them can efficiently calculate a long-length DFT/IDFT, they can not be realized in a single-chip. In industry, it is important that a balance between the size of the chip and the calculation speed needs to be maintained. Consequently, an apparatus for efficiently computing the long-length DFT/IDFT is rather attractive for some high-speed real-time DFT-based applications.

### SUMMARY OF THE INVENTION

An object of the present invention is to provide an apparatus for calculating an N-point DFT/IDFT by utilizing the Cooley-Tukey algorithm. The N-point DFT/IDFT is factored as a plurality of N₁-point DFTs/IDFTs and a plurality of N₂-point DFTs/IDFTs. Each of the N, N₁, and N₂ is a power of two and N₂ is not greater than N₁. The apparatus comprises a store unit, a calculation unit, and a control unit. The store unit comprises a first memory for storing a plurality of first data and a second memory for storing a plurality of second data. The store unit is configured to receive a plurality of first control signals to control operations of the first memory and the second memory. The calculation unit comprises a plurality of P_{N}_{₁}_{/M} (M) calculation units for computing the N₁-point DFTs and the N₂-point DFTs in sequence, wherein each of the output serves as the input of the next calculation. M is a power of two, wherein the number ranges from N₁ to two. Each of the P_{N}_{₁}_{/M} (M) is an N₁ by N₁ matrix, is a direct sum of N₁/M P(M) matrixes, and has the form of

$${P}_{{N}_{1} / M} ( M ) = P ( M ) ⊕ … ⊕ P ( M ) = [ \begin{matrix}P ( M ) & 0 & … & 0 \\ 0 & P ( M ) & … & 0 \\ ⋮ & ⋮ & ⋰ & ⋮ \\ 0 & 0 & … & P ( M )\end{matrix} ] , \\ P ( M ) = [ \begin{matrix}{I}_{M / 2} & 0 \\ 0 & F ( M / 2 )\end{matrix} ] [ \begin{matrix}{I}_{M / 2} & {I}_{M / 2} \\ {I}_{M / 2} & - {I}_{M / 2}\end{matrix} ] , \\ F ( M / 2 ) = [ \begin{matrix}{W}_{M}^{0} & 0 & … & 0 \\ 0 & {W}_{M}^{1} & … & 0 \\ ⋮ & ⋮ & ⋰ & ⋮ \\ 0 & 0 & … & {W}_{M}^{M / {2}^{- 1}}\end{matrix} ] ,$$

wherein I_{M/2} is an M/2 by M/2 unit matrix and W_{M}=e^{-j2π/M}. The calculation unit is configured to receive a plurality of second control signals, a plurality of third control signals, the first data, and the second data. The second control signals are configured to control data flow of the P_{N}_{₁}_{/M}(M) calculation units. The third control signals are configured to set a calculation point of the calculation unit to execute the corresponding P_{N}_{₁}_{/M}(M) calculations and to generate a plurality of output data. The control unit is configured to generate the first control signals, the second control signals, and the third control signals.

The apparatus of the present invention can be made as a small-sized chip to achieve a long-length DFT/IDFT within an acceptable amount of time. That is, the present invention finds a balance between the size of the chip and the calculation time. With its acceptable calculation speed, the present invention can be made as a single chip to realize the fast DFT/IDFT algorithm.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a first embodiment of the present invention;

FIG. 2 illustrates the circuit diagram of each of the P_{N}_{₁}_{/M} (M) calculation units P₀, P₁, . . . , and Pᵢ; and

FIG. 3 illustrates a second embodiment of the present invention.

### DESCRIPTION OF THE PREFERRED EMBODIMENT

A first embodiment of the present invention is an apparatus for calculating an N-point Discrete Fourier Transform (DFT) utilizing the Cooley-Tukey algorithm. Although the first embodiment works on the DFT, it can also be applied to the IDFT as well due to similar concepts and operations. Based on the Cooley-Tukey algorithm, an N-point DFT is factored as a plurality of N₁-point DFTs and a plurality of N₂-point DFTs, such as several sets of (N/N₁) N₁-point DFTs and one set of (N/N₂) N₂-point DFT. N, N₁, and N₂ are numbers, wherein each of the number is a power of two and N₂ is not greater than N₁. Since the first embodiment is quite complicated, the details of the Cooley-Tukey algorithm are first described and then the details of the apparatus are addressed.

First, the factorization of the N-point DFT in the first embodiment is described. If N=N₁×N₁₂, the first embodiment uses the Cooley-Tukey algorithm to factor the N-point DFT as N₁₂ N₁-point DFTs and N complex multiplications (i.e. multiplication of complex numbers), and N₁₂ N₁-point DFTs. Next, if N₁₂ is greater than N₁ and N₁₂=N₁×N₁₃, then the first embodiment uses the Cooley-Tukey algorithm to factor each of the N₁₂-point DFTs as N₁₃ N₁-point DFTs, N₁₂ complex multiplications, and N₁ N₁₃-point DFTs. That is, the N₁ N₁₂-point DFTs are factored as N₁₃×N₁=N₁₂ N₁-point DFTs, N₁₂×N₁=N complex multiplications, and N₁×N₁ N₁₃-point DFTs. If N₁₃ is greater than N₁, then the first embodiment uses the Cooley-Tukey algorithm to continue the factorization.

By using the Cooley-Tukey algorithm, the first embodiment considers the N as the multiplication of at least one N₁ and an N₂. That is, N=N₁×N₁× . . . ×N₂, wherein N₂ is smaller than N₁. Thus, by calculating (log_{N}_{₁} N)×(N/N₁) N₁-point DFTs, N×(└ log_{N}_{₁} N┐) complex multiplications, and N/N₂ N₂-point DFTs, the N-point DFT can be completed. Furthermore, if N=N₁×N₁× . . . ×N₁, the calculations of └ log_{N}_{₁} N┐×(N/N₁) N₁-point DFTs and N×(log_{N}_{₁} N−1) complex multiplications will complete the N-point DFT. People skilled in the field of the DFT should be able to understand the Cooley-Tukey algorithm, so the theory of the Cooley-Tukey algorithm is not described here. The following description is based on the assumption that N=N₁×N₁× . . . ×N₂. That is, the N-point DFT is factored as several sets of (N/N₁) N₁-point DFTs and one set of (N/N₂) N₂-point DFTs. Nevertheless, the following description can be applied to the situation when N=N₁×N₁× . . . ×N₁.

After factoring the N-point DFT by the Cooley-Tukey algorithm, the factored N₁-point DFTs and N₂-point DFTs should be calculated in sequence. For each of the calculations, the output serves as the input of the next calculation. That is, each of the results of the (N/N₁) N₁-point DFTs is the input of the next (N/N₁) N₁-point DFT or the input of the (N/N₂) N₂-point DFT. The result of the N₂-point DFTs then becomes the result of the N-point DFT, which is characteristic of the Cooley-Tukey algorithm.

Next, the calculations of each N₁-point DFT and each N₂-point DFTs are described. One N₁-point DFT is used as an example. Assume that an input data is X=[x₀, x₁ . . . x_{N1-1}]^{T}, then the N₁-point DFT is Y=W(N₁)X, wherein Y is the result and

$$W ( {N}_{1} ) = [ \begin{matrix}1 & 1 & 1 & … & 1 \\ 1 & {W}_{{N}_{1}}^{1 \times 1} & {W}_{{N}_{1}}^{1 \times 2} & … & {W}_{{N}_{1}}^{1 \times ( {N}_{1} - 1 )} \\ 1 & {W}_{{N}_{1}}^{2 \times 1} & {W}_{{N}_{1}}^{2 \times 2} & … & {W}_{{N}_{1}}^{2 \times ( {N}_{1} - 1 )} \\ ⋮ & ⋮ & ⋮ & ⋰ & ⋮ \\ 1 & {W}_{{N}_{1}}^{( {N}_{1} - 1 ) \times 1} & {W}_{{N}_{1}}^{( {N}_{1} - 1 ) \times 2} & … & {W}_{{N}_{1}}^{( {N}_{1} - 1 ) \times ( {N}_{1} - 1 )}\end{matrix} ] .$$

The first embodiment adopts an easier approach for calculating Y=W(N₁)X. To be more specific, the first embodiment calculates Z=P_{N}_{₁}_{/2}(2) . . . P₂(N₁/2)P₁(N₁)X, wherein each of the P_{N}_{₁}_{/M} (M) has the form of

$${P}_{{N}_{1} / M} ( M ) = P ( M ) ⊕ … ⊕ P ( M ) = [ \begin{matrix}P ( M ) & 0 & … & 0 \\ 0 & P ( M ) & … & 0 \\ ⋮ & ⋮ & ⋰ & ⋮ \\ 0 & 0 & … & P ( M )\end{matrix} ] , \\ wherein$$

$$P ( M ) = [ \begin{matrix}{I}_{M / 2} & 0 \\ 0 & F ( M / 2 )\end{matrix} ] [ \begin{matrix}{I}_{M / 2} & {I}_{M / 2} \\ {I}_{M / 2} & - {I}_{M / 2}\end{matrix} ] , \\ F ( M / 2 ) = [ \begin{matrix}{W}_{M}^{0} & 0 & … & 0 \\ 0 & {W}_{M}^{1} & … & 0 \\ ⋮ & ⋮ & ⋰ & ⋮ \\ 0 & 0 & … & {W}_{M}^{M / {2}^{- 1}}\end{matrix} ] ,$$

I_{M/2} is an (M/2)×(M/2) identity matrix and W_{M}=e^{-j2π/M} is a twiddle factor. That is, the matrix P_{N}_{₁}_{/M} (M) is the direct sum of the N₁/M M×M matrixes P(M). The relationship between Y and Z is that their corresponding addresses are bit-reversal. That is, Z=[z₀, z₁, z₂, z₃, z₄, . . . z_{N1-1}]^{T}=[y₀, y_{N1/2}, y_{N1/4}, y_{3·(N1/8)}, . . . y_{N1-1}]. Thus, when writing data, the accuracy of the addressing for circuit design should be considered.

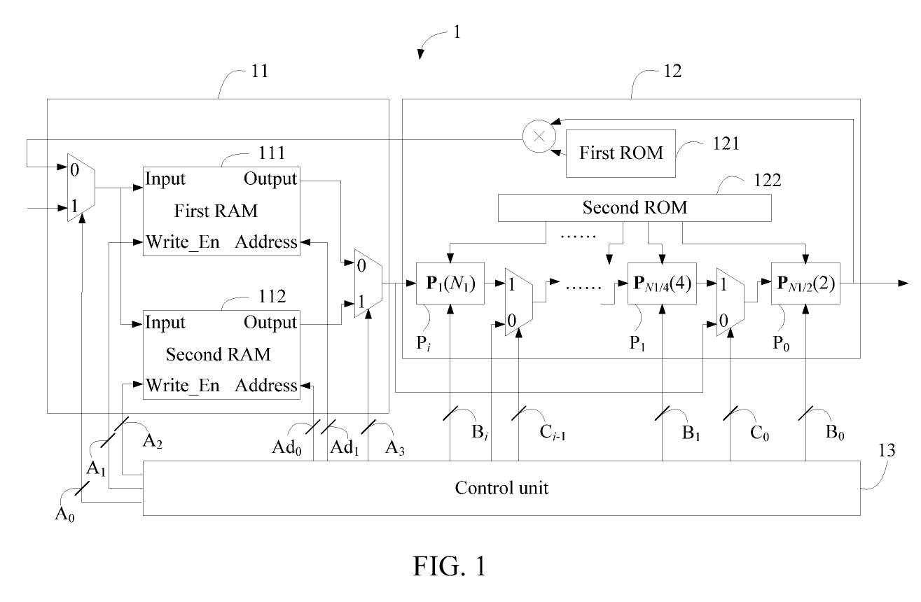

After the description of the algorithm, the apparatus is explained. FIG. 1 illustrates an apparatus 1 of the first embodiment. The apparatus 1 comprises a store unit 11, a calculation unit 12, and a control unit 13. The apparatus 1 finishes the N₁-point DFTs and the N₂-point DFTs in sequence, wherein the output of each calculation serves as the input of the next calculation.

In the first embodiment, random access memory (RAM) is chosen to configure the store unit, wherein the store unit 11 comprises a first RAM 111 for storing a plurality of first data and a second RAM 112 for storing a plurality of second data. In other words, the input data X=[x₀, x₁ . . . x_{N1-1}]T of each N₁-point DFT or the input data X=[x₀, x₁ . . . x_{N2-1}] of each N₂-point DFT are stored in the first RAM 111 or the second RAM 112. When applied to the N-point DFT, the memory address spaces of the first RAM 111 and the second RAM 112 are both N/2.

Furthermore, the store unit 11 is configured to receive a plurality of first control signals, i.e. A₀, A₁, A₂, A₃, Ad₀, and Ad₁ to control the operations of the first memory and the second memory. The first control signals comprise a set of address signals Ad₀ and Ad₁, a set of data selection signals A₀ and A₃, and a set of read/write control signals A₁ and A₂. More specifically, the address signals Ad₁ and Ad₀ indicate the read/write addresses of the first RAM 111 and the second RAM 112, respectively. The data selection signal A₀ controls the source of the data to be written into the memory. When A₀=1, the source of the data is the initial data, i.e. the inputted N-point sequence for the DFT calculation. When A₀=0, the source of the data is the output data of the calculation unit 12, i.e. the output of the N/N₁ N₁-point DFTs.

The read/write control signals A₁ and A₂ control the read/write operations of the first RAM 111 and the second RAM 112, respectively. The combination of the signals A₀, A₁, and A₂ is summarized in Table 1 for convenience. Signal A₃ controls the source of the inputted data in the calculation unit 12 for the computation of the N₁-point DFT or the N₂-point DFT. The source of the data is the second RAM 112 when A₃=1, while the source of the data is the first RAM 111 when A₃=0.

TABLE 1

| | A₀ = 0 | A₀ = 1 |
|---|---|---|
| A₁ = 0 | Read out the data in the first RAM 111 | Read out the data in the first RAM 111 |
| A₁ = 1 | Write the data into the first RAM 111 | Write the data into the first RAM 111 |
| | The source of the data is the output data | The source of the data is the initial data |
| | of the calculation unit 12 | |
| A₂ = 0 | Read out the data in the second RAM | Read out the data in the second RAM |
| | 112 | 112 |
| A₂ = 1 | Write the data into the second RAM | Write the data into the second RAM 112 |
| | 112 | The source of the data is the initial data |
| | The source of the data is the output data | |
| | of the calculation unit 12 | |

Consequently, A₀ is set to 1 for reading the initial sequence when the first embodiment intends to execute the factored N₁-point DFTs and the N₂-point DFTs. At this time, A₁=Ā₂ and A₁ and A₂ change every clock cycle. During the processes of reading the initial sequence of the N-point DFT, data with odd addresses are sequentially written into the first RAM 111 and data with even addresses are sequentially written into the second RAM 112. In other words, if x₀, x₁ . . . x_{N-1} is the inputted sequence of the N-point DFT, x₀, x₂ . . . x_{N-2} are written into the memory whose addresses are 0, 1, . . . , and (N/2−1) of the second RAM 112 and x₁, x₃ . . . x_{N-1} are written into the memory whose addresses are 0, 1, . . . , and (N/2−1) of the first RAM 111. When all data are written in, the control unit 13 sets A₀=0 for the next step to complete every factorization and calculation of the Cooley-Tukey algorithm. This step also shows that the source of the data of the apparatus 1 is the output data of the calculation unit 12.

The calculation unit 12 comprises a plurality of P_{N}_{₁}_{/M} (M) calculation units, i.e. P₀, P₁, . . . , and Pᵢ, to calculate Z=P_{N}_{₁}_{/2} (2) . . . P₂ (N₁/2)P₁(N₁)X. That is, the calculation of each P_{N}_{₁}_{/M} (M) is calculated by the calculation units P₀, P₁, . . . , and Pᵢ to complete the N₁-point DFTs and the N₂-point DFTs. The calculation result of the N/N₁ N₁-point DFTs is fed back as the input of the next N/N₁ N₁-point DFTs or N/N₂ N₂-point DFTs. The calculation unit 12 comprises a first read only memory (ROM) 121 and a second ROM 122 to provide twiddle factors.

Both the computation of each N₁-point DFT and N₂-point DFT by the P_{N}_{₁}_{/M} (M) calculation units P₀, P₁, . . . , and Pᵢ and the use of the calculation result as the next input are described in detail here. The calculation unit 12 receives a plurality of third control signals C₀, . . . , Cᵢ₋₁, the first data, and the second data. The third control signals C₀, . . . , Cᵢ₋₁ are used to set a calculation point, i.e. the number of points of the DFT, so that the calculation unit 12 is able to select the corresponding P_{N}_{₁}_{/M} (M) calculation units P₀, P₁, . . . , and Pᵢ to operate on the first data and the second data to generate a plurality of output data. In the first embodiment, the calculation point is N₁ or N₂. More specifically, the calculation unit 12 completes a two-point DFT (or IDFT) when C₀=0. When C₀=1 and C₁=0, the calculation unit 12 is configured to complete a four-point DFT. Similarly, when C₀ to Cᵢ₋₂ are all one and Cᵢ₋₁=0, the calculation unit 12 is configured to complete an (N₁/2)-point DFT. When C₀ to Cᵢ₋₁ are all one, the calculation unit 12 is configured to complete an N₁-point DFT. By setting C₀, C₁, . . . , Cᵢ₋₁, the calculation unit 12 is able to complete a 2^{k}-point DFT, wherein 2^{k}≦N. The calculation unit 12 also receives a plurality of second control signals B₀, . . . , Bᵢ to control data flow of the P_{N}_{₁}_{/M} (M) calculation units P₀, P₁, and Pᵢ.

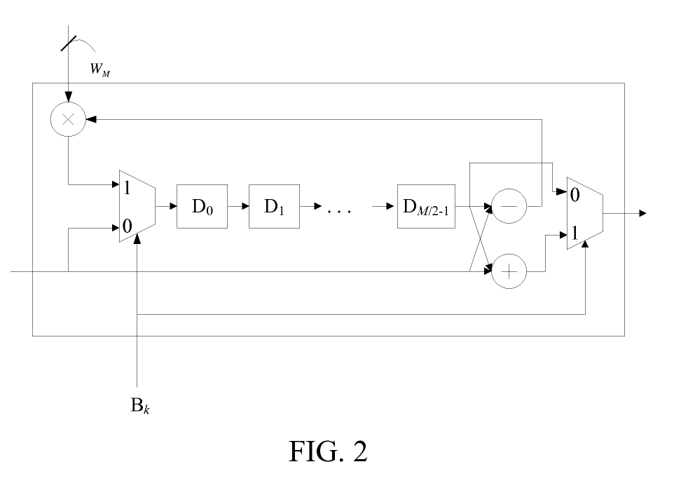

FIG. 2 illustrates the circuit diagram of each of the P_{N}_{₁}_{/M} (M) calculation units P₀, P₁, . . . , and Pᵢ, which is a one dimensional systolic structure with a twiddle factor W_{M} as the input, wherein each of the block D₀, . . . , D_{M/2-1}, in FIG. 2 is a delay element delaying a clock cycle and Bₖ is one of the third control signals. From FIG. 2, it can be seen that the latency of each calculation unit P₀, P₁, . . . , or Pᵢ is M/2 clock cycles. Thus, in FIG. 1, assuming that C₀ to Cᵢ₋₁ are all one (i.e. to perform N₁-point DFT), the total latency required from inputting the first piece of data into the calculation unit 12 to outputting the first piece of data from the calculation unit 12 is N₁/2+N₁/4+ . . . +1=N₁−1 clock cycles.

On the other hand, when the calculation unit 12 processes N₁-point DFT, N₁ continuous points of data are read from the first RAM 111 or the second RAM 112 for input into the calculation unit 12. When the last point of data is read out from RAM, the calculation unit 12 also outputs the result of the calculation of the first point of data. In order to maximize the efficiency of the memory, the output data of the calculation unit 12 can be written into the first RAM 111 or the second RAM 112 in the following N₁ continuous clock cycles. It is noted that the order of the output of the P_{N}_{₁}_{/M} (M) unit and the order of the normal N₁-point DFT computation are bit-reversal, part of the address bits (i.e. log N₁ bits of the address bits) has to be bit-reversed, i.e. reverse permutation. According to the aforementioned descriptions, the read/write status of the first RAM 111 or the second RAM 112 changes every N₁ clock cycles. If C₀, . . . , Cᵢ₋₁ are in a way that the calculation unit 12 would complete 2^{k}-point DFT and 2^{k}≦N₁, then the first RAM 111 and the second RAM 112 can be set by the control unit 13 to change the read/write status every 2^{k} clock cycles.

The aforementioned first control signals A₀, A₁, A₂, A₃, Ad₀, and Ad₁, the second control signals B₀ and B₁, and the third control signals C₀, . . . , Cᵢ₋₁ are generated by the control unit 13.

The second embodiment further sets N=32 and N₁=4 to explain the present invention. Table 2 shows the input sequence x₀, x₁, x₂ . . . x₃₁ of the 32 points.

TABLE 2

N₁

| N₁₂ | 0 | 1 | 2 | 3 |
|---|---|---|---|---|
| 0 | x₀ | x₈ | x₁₆ | x₂₄ |
| 1 | x₁ | x₉ | x₁₇ | x₂₅ |
| 2 | x₂ | x₁₀ | x₁₈ | x₂₆ |
| 3 | x₃ | x₁₁ | x₁₉ | x₂₇ |
| 4 | x₄ | x₁₂ | x₂₀ | x₂₈ |
| 5 | x₅ | x₁₃ | x₂₁ | x₂₉ |
| 6 | x₆ | x₁₄ | x₂₂ | x₃₀ |
| 7 | x₇ | x₁₅ | x₂₃ | x₃₁ |

First, for each of the rows in Table 2, the second embodiment uses the Cooley-Tukey algorithm to complete a 4-point DFT and further multiplies a twiddle factor to the DFT result. The result is shown in Table 3.

TABLE 3

N₁

| N₁₂ | 0 | 1 | 2 | 3 |
|---|---|---|---|---|
| 0 | a₀ | a₈ | a₁₆ | a₂₄ |
| 1 | a₁ | a₉ | a₁₇ | a₂₅ |
| 2 | a₂ | a₁₀ | a₁₈ | a₂₆ |
| 3 | a₃ | a₁₁ | a₁₉ | a₂₇ |
| 4 | a₄ | a₁₂ | a₂₀ | a₂₈ |
| 5 | a₅ | a₁₃ | a₂₁ | a₂₉ |
| 6 | a₆ | a₁₄ | a₂₂ | a₃₀ |
| 7 | a₇ | a₁₅ | a₂₃ | a₃₁ |

Next, for each column in Table 3, the second embodiment uses the Cooley-Tukey algorithm to calculate an 8-point DFT. First, the four columns of the Table 3 are represented by the four two-dimensional matrixes from Table 4(a) to Table 4(d).

TABLE 4(a)

N₁

| N₁₃ | 0 | 1 | 2 | 3 |
|---|---|---|---|---|
| 0 | a₀ | a₂ | a₄ | a₆ |
| 1 | a₁ | a₃ | a₅ | a₇ |

TABLE 4(b)

N₁

| N₁₃ | 0 | 1 | 2 | 3 |
|---|---|---|---|---|
| 0 | a₈ | a₁₀ | a₁₂ | a₁₄ |
| 1 | a₉ | a₁₁ | a₁₃ | a₁₅ |

TABLE 4(c)

N₁

| N₁₃ | 0 | 1 | 2 | 3 |
|---|---|---|---|---|
| 0 | a₁₆ | a₁₈ | a₂₀ | a₂₂ |
| 1 | a₁₇ | a₁₉ | a₂₁ | a₂₃ |

TABLE 4(d)

N₁

| N₁₃ | 0 | 1 | 2 | 3 |
|---|---|---|---|---|
| 0 | a₂₄ | a₂₆ | a₂₈ | a₃₀ |
| 1 | a₂₅ | a₂₇ | a₂₉ | a₃₁ |

Next, for each row in Tables 4(a) to 4(d), the 4-point DFT is calculated and then multiplied by the twiddle factors. The results are shown in Tables 5(a) to 5(d).

TABLE 5(a)

N₁

| N₁₃ | 0 | 1 | 2 | 3 |
|---|---|---|---|---|
| 0 | b₀ | b₂ | b₄ | b₆ |
| 1 | b₁ | b₃ | b₅ | b₇ |

TABLE 5(b)

N₁

| N₁₃ | 0 | 1 | 2 | 3 |
|---|---|---|---|---|
| 0 | b₈ | b₁₀ | b₁₂ | b₁₄ |
| 1 | b₉ | b₁₁ | b₁₃ | b₁₅ |

TABLE 5(c)

N₁

| N₁₃ | 0 | 1 | 2 | 3 |
|---|---|---|---|---|
| 0 | b₁₆ | b₁₈ | b₂₀ | b₂₂ |
| 1 | b₁₇ | b₁₉ | b₂₁ | b₂₃ |

TABLE 5(d)

N₁

| N₁₃ | 0 | 1 | 2 | 3 |
|---|---|---|---|---|
| 0 | b₂₄ | b₂₆ | b₂₈ | b₃₀ |
| 1 | b₂₅ | b₂₇ | b₂₉ | b₃₁ |

Finally, for each column in Tables 5(a) to 5(d), the 2-point DFT was calculated. That is, there are 16 2-point DFTs. The results are shown from Table 6(a) to 6(d).

TABLE 6(a)

N₁

| N₁₃ | 0 | 1 | 2 | 3 |
|---|---|---|---|---|
| 0 | c₀ | c₂ | c₄ | c₆ |
| 1 | c₁ | c₃ | c₅ | c₇ |

TABLE 6(b)

N₁

| N₁₃ | 0 | 1 | 2 | 3 |
|---|---|---|---|---|
| 0 | c₈ | c₁₀ | c₁₂ | c₁₄ |
| 1 | c₉ | c₁₁ | c₁₃ | c₁₅ |

TABLE 6(c)

N₁

| N₁₃ | 0 | 1 | 2 | 3 |
|---|---|---|---|---|
| 0 | c₁₆ | c₁₈ | c₂₀ | c₂₂ |
| 1 | c₁₇ | c₁₉ | c₂₁ | c₂₃ |

TABLE 6(d)

N₁

| N₁₃ | 0 | 1 | 2 | 3 |
|---|---|---|---|---|
| 0 | c₂₄ | c₂₆ | c₂₈ | c₃₀ |
| 1 | c₂₅ | c₂₇ | c₂₉ | c₃₁ |

According to the aforementioned descriptions, the 32-point DFT can be sequentially accomplished by calculating 8 4-point DFTs, calculating 8 4-point DFTs, and calculating 16 2-point DFTs.

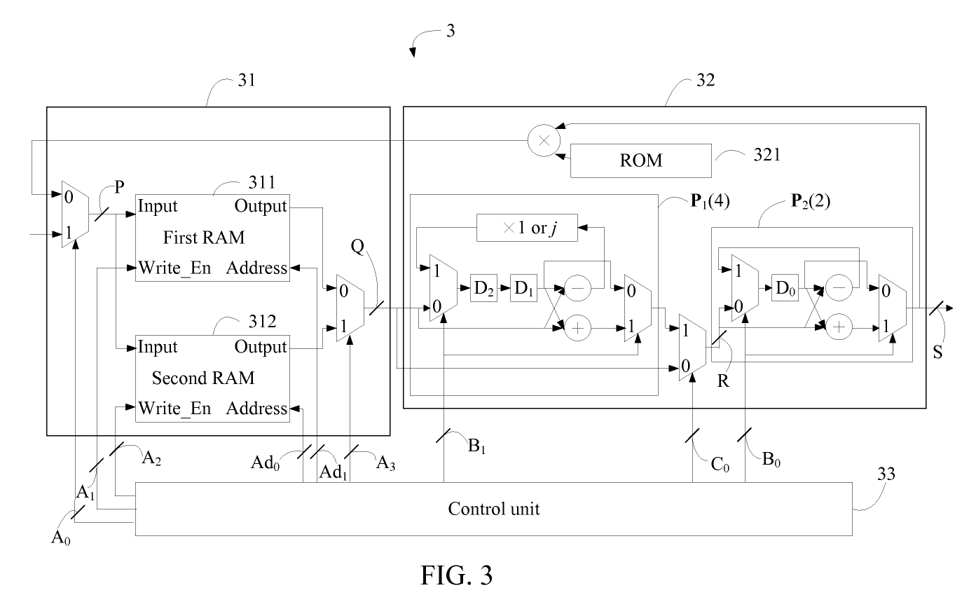

FIG. 3 illustrates an apparatus 3 that performs the second embodiment. The apparatus 3 comprises a store unit 31, a calculation unit 32, and a control unit 33. The store unit 31 comprises a first RAM 311 and a second RAM 312, wherein each has 16 memory address spaces. The calculation unit 32 comprises a ROM 321, a P₁(4) calculation unit, and a P₂(2) calculation unit. The second ROM of the second embodiment is directly made by a logical circuit. The control unit 33 generates a plurality of first control signals A₀, A₁, A₂, A₃, Ad₀, and Ad₁, a plurality of second control signals B₀ and B₁, and a third control signal C₀. The calculation unit 32 performs 4-point DFTs when C₀=1, while the calculation unit 32 performs 2-point DFTs when C₀=0. The process of the whole transformation can be classified into four phases as shown in Table 7. In Table 7, column P represents data xᵢ inputted to the store unit 31, column Q represent data qᵢ outputted to the calculation unit 32 from the store unit 31, column R represent the data source of the P₂(2) calculation unit denoted rᵢ, column S represents the output data of the calculation unit 32, W_{M}ⁿ=(e^{-j2π/M})ⁿ represents the twiddle factor, and x represents the ignoring. The details are described in the following paragraphs.

Phase 0 (cycles 0˜31): The data sequence x₀, x₁, . . . x₃₁ is inputted. At this time, A₀=1. According to the A₁ and Ad₁ of the first control signals, x₁, x₃, . . . x₃₁ is stored into the first RAM 311 at addresses 0, 1, . . . , and 15. According to the A₂ and Ad₀ of the first control signals, x₀, x₂, . . . x₃₀ is stored into the second RAM 312 at address 0, 1, . . . , and 15.

Phase 1 (cycles 31˜66): The control signal C₀ of the third control signals is set (C₀=1). The calculation unit 32 completes the 8 4-point DFTs of the first stage. The data of the first point is read from the second RAM 312 at cycle 32, while the result of the first point is generated at cycle 35, which is written back to the second RAM 312, wherein A₀=0 at this time. Since the order of the output of the calculation unit 32 is bit-reversed, the address should be adjusted when the output of the calculation unit 32 is written back into the first RAM 311 or the second RAM 312.

Phase 2 (cycles 63˜98): C₀=1. The calculation unit 32 completes the 8 4-point DFTs in the second stage. The calculation process is similar to the process in Phase 1.

Phase 3 (cycle 98˜131): The calculation unit 32 completes the 16 2-point DFTs in the third stage. The data of the first point is read at cycle 99, wherein C₀=0 at this moment. The result of the first point is generated at cycle 100, wherein the result is also the result of the first point of the 32-point DFT. At cycle 99, A₀ is set to 0. The new input data sequence x₀, x₁, . . . x₃₁ of the 32-point DFT is processed by storing x₁, x₃, . . . x₃₁ into the first RAM 311 at address 0, 1, . . . , and 15 and storing x₀, x₂, . . . x₃₀ into the second RAM 312 at address 0, 1, . . . , and 15 according to the A₁, A₂, Ad₀, and Ad₁. Next, the next new 32-point DFT is calculated and processed back to Phase 1 again.

TABLE 7

| cy | A₀ | A₁ | A₂ | Ad0 | Ad1 | A₃ | Q | B₁ | D₂ | D₁ | R | B₀ | D₀ | S | P | C₀ |
|---|---|---|---|---|---|---|---|---|---|---|---|---|---|---|---|---|
| 0 | 1 | 0 | 1 | 0000 | x | x | x | x | x | x | x | x | x | x | x₀ | x |
| 1 | 1 | 1 | 0 | X | 0000 | x | x | x | x | x | x | x | x | x | x₁ | x |
| 2 | 1 | 0 | 1 | 0001 | x | x | x | x | x | x | x | x | x | x | x₂ | x |
| 3 | 1 | 1 | 0 | X | 0001 | x | x | x | x | x | x | x | x | x | x₃ | x |
| 4 | 1 | 0 | 1 | 0010 | x | x | x | x | x | x | x | x | x | x | x₄ | x |
| 5 | 1 | 1 | 0 | X | 0010 | x | x | x | x | x | x | x | x | x | x₅ | x |
| 6 | 1 | 0 | 1 | 0011 | x | x | x | x | x | x | x | x | x | x | x₆ | x |
| 7 | 1 | 1 | 0 | X | 0011 | x | x | x | x | x | x | x | x | x | x₇ | x |
| 8 | 1 | 0 | 1 | 0100 | x | x | x | x | x | x | x | x | x | x | x₈ | x |
| 9 | 1 | 1 | 0 | X | 0100 | x | x | x | x | x | x | x | x | x | x₉ | x |
| 10 | 1 | 0 | 1 | 0101 | x | x | x | x | x | x | x | x | x | x | x₁₀ | x |
| 11 | 1 | 1 | 0 | X | 0101 | x | x | x | x | x | x | x | x | x | x₁₁ | x |
| 12 | 1 | 0 | 1 | 0110 | x | x | x | x | x | x | x | x | x | x | x₁₂ | x |
| 13 | 1 | 1 | 0 | X | 0110 | x | x | x | x | x | x | x | x | x | x₁₃ | x |
| 14 | 1 | 0 | 1 | 0111 | x | x | x | x | x | x | x | x | x | x | x₁₄ | x |
| 15 | 1 | 1 | 0 | X | 0111 | x | x | x | x | x | x | x | x | x | x₁₅ | x |
| 16 | 1 | 0 | 1 | 1000 | x | x | x | x | x | x | x | x | x | x | x₁₆ | x |
| 17 | 1 | 1 | 0 | X | 1000 | x | x | x | x | x | x | x | x | x | x₁₇ | x |
| 18 | 1 | 0 | 1 | 1001 | x | x | x | x | x | x | x | x | x | x | x₁₈ | x |
| 19 | 1 | 1 | 0 | X | 1001 | x | x | x | x | x | x | x | x | x | x₁₉ | x |
| 20 | 1 | 0 | 1 | 1010 | x | x | x | x | x | x | x | x | x | x | x₂₀ | x |
| 21 | 1 | 1 | 0 | X | 1010 | x | x | x | x | x | x | x | x | x | x₂₁ | x |
| 22 | 1 | 0 | 1 | 1011 | x | x | x | x | x | x | x | x | x | x | x₂₂ | x |
| 23 | 1 | 1 | 0 | X | 1011 | x | x | x | x | x | x | x | x | x | x₂₃ | x |
| 24 | 1 | 0 | 1 | 1100 | x | x | x | x | x | x | x | x | x | x | x₂₄ | x |
| 25 | 1 | 1 | 0 | X | 1100 | x | x | x | x | x | x | x | x | x | x₂₅ | x |
| 26 | 1 | 0 | 1 | 1101 | x | x | x | x | x | x | x | x | x | x | x₂₆ | x |
| 27 | 1 | 1 | 0 | X | 1101 | x | x | x | x | x | x | x | x | x | x₂₇ | x |
| 28 | 1 | 0 | 1 | 1110 | x | x | x | x | x | x | x | x | x | x | x₂₈ | x |
| 29 | 1 | 1 | 0 | X | 1110 | x | x | x | x | x | x | x | x | x | x₂₉ | x |
| 30 | 1 | 0 | 1 | 1111 | x | x | x | x | x | x | x | x | x | x | x₃₀ | x |
| 31 | 1 | 1 | 0 | 0000 | 1111 | x | x | x | x | x | x | x | x | x | x₃₁ | x |
| 32 | x | 0 | 0 | 0100 | x | 1 | q₀ = x₀ | 0 | x | x | x | x | x | x | x | x |
| 33 | x | 0 | 0 | 1000 | x | 1 | q₁ = x₈ | 0 | q₀ | x | x | x | x | x | x | x |
| 34 | x | 0 | 0 | 1100 | x | 1 | q₂ = x₁₆ | 1 | q₁ | q₀ | r₀ = q₀ + q₂ | 0 | x | x | x | 1 |
| 35 | 0 | 0 | 1 | 0000 | 0000 | 1 | q₃ = x₂₄ | 1 | (q₀ − q₂)W₄⁰ | q₁ | r₁ = q₁ + q₃ | 1 | r₀ | r₀ + r₁ | a₀ | 1 |
| 36 | 0 | 0 | 1 | 1000 | 0100 | 0 | q₀ = x₁ | 0 | (q₁ − q₃)W₄¹ | (q₀ − q₂)W₄⁰ | r₂ = (q₀ − q₂)W₄⁰ | 0 | r₀ − r₁ | r₀ − r₁ | a₁₆ | 1 |
| 37 | 0 | 0 | 1 | 0100 | 1000 | 0 | q₁ = x₉ | 0 | q₀ | (q₁ − q₃)W₄¹ | r₃ = (q₁ − q₃)W₄¹ | 1 | r₂ | r₂ + r₃ | a₈ | 1 |
| 38 | 0 | 0 | 1 | 1100 | 1100 | 0 | q₂ = x₁₇ | 1 | q₁ | q₀ | r₀ = q₀ + q₂ | 0 | r₂ − r₃ | r₂ − r₃ | a₂₄ | 1 |
| 39 | 0 | 1 | 0 | 0001 | 0000 | 0 | q₃ = x₂₅ | 1 | (q₀ − q₂)W₄⁰ | q₁ | r₁ = q₁ + q₃ | 1 | r₀ | r₀ + r₁ | a₁ | 1 |
| 40 | 0 | 1 | 0 | 0101 | 1000 | 1 | q₀ = x₂ | 0 | (q₁ − q₃)W₄¹ | (q₀ − q₂)W₄⁰ | r₂ = (q₀ − q₂)W₄⁰ | 0 | r₀ − r₁ | r₀ − r₁ | a₁₇ | 1 |
| 41 | 0 | 1 | 0 | 1001 | 0100 | 1 | q₁ = x₁₀ | 0 | q₀ | (q₁ − q₃)W₄¹ | r₃ = (q₁ − q₃)W₄¹ | 1 | r₂ | r₂ + r₃ | a₉ | 1 |
| 42 | 0 | 1 | 0 | 1101 | 1100 | 1 | q₂ = x₁₈ | 1 | q₁ | q₀ | r₀ = q₀ + q₂ | 0 | r₂ − r₃ | r₂ − r₃ | a₂₅ | 1 |
| 43 | 0 | 0 | 1 | 0001 | 0001 | 1 | q₃ = x₂₆ | 1 | (q₀ − q₂)W₄⁰ | q₁ | r₁ = q₁ + q₃ | 1 | r₀ | r₀ + r₁ | a₂ | 1 |
| 44 | 0 | 0 | 1 | 1001 | 0101 | 0 | q₀ = x₃ | 0 | (q₁− q₃)W₄¹ | (q₀ − q₂)W₄⁰ | r₂ = (q₀ − q₂)W₄⁰ | 0 | r₀ − r₁ | r₀ − r₁ | a₁₈ | 1 |
| 45 | 0 | 0 | 1 | 0101 | 1001 | 0 | q₁ = x₁₁ | 0 | q₀ | (q₁ − q₃)W₄¹ | r₃ = (q₁ − q₃) W₄¹ | 1 | r₂ | r₂ + r₃ | a₁₀ | 1 |
| 46 | 0 | 0 | 1 | 1101 | 1101 | 0 | q₂ = x₁₉ | 1 | q₁ | q₀ | r₀ = q₀ + q₂ | 0 | r₂ − r₃ | r₂ − r₃ | a₂₆ | 1 |
| 47 | 0 | 1 | 0 | 0010 | 0001 | 0 | q₃ = x₂₇ | 1 | (q₀ − q₂)W₄⁰ | q₁ | r₁ = q₁ + q₃ | 1 | r₀ | r₀ + r₁ | a₃ | 1 |
| 48 | 0 | 1 | 0 | 0110 | 1001 | 1 | q₀ = x₄ | 0 | (q₁ − q₃)W₄¹ | (q₀ − q₂)W₄⁰ | r₂ = (q₀ − q₂)W₄⁰ | 0 | r₀ − r₁ | r₀ − r₁ | a₁₉ | 1 |
| 49 | 0 | 1 | 0 | 1010 | 0101 | 1 | q₁ = x₁₂ | 0 | q₀ | (q₁ − q₃)W₄¹ | r₃ = (q₁ − q₃)W₄¹ | 1 | r₂ | r₂ + r₃ | a₁₁ | 1 |
| 50 | 0 | 1 | 0 | 1110 | 1101 | 1 | q₂ = x₂₀ | 1 | q₁ | q₀ | r₀ = q₀ + q₂ | 0 | r₂ − r₃ | r₂ − r₃ | a₂₇ | 1 |
| 51 | 0 | 0 | 1 | 0010 | 0010 | 1 | q₃ = x₂₈ | 1 | (q₀ − q₂)W₄⁰ | q₁ | r₁ = q₁ + q₃ | 1 | r₀ | r₀ + r₁ | a₄ | 1 |
| 52 | 0 | 0 | 1 | 1010 | 0110 | 0 | q₀ = x₅ | 0 | (q₁ − q₃)W₄¹ | (q₀ − q₂)W₄⁰ | r₂ = (q₀ − q₂)W₄⁰ | 0 | r₀ − r₁ | r₀ − r₁ | a₂₀ | 1 |
| 53 | 0 | 0 | 1 | 0110 | 1010 | 0 | q₁ = x₁₃ | 0 | q₀ | (q₁ − q₃)W₄¹ | r₃ = (q₁ − q₃)W₄¹ | 1 | r₂ | r₂ + r₃ | a₁₂ | 1 |
| 54 | 0 | 0 | 1 | 1110 | 1110 | 0 | q₂ = x₂₁ | 1 | q₁ | q₀ | r₀ = q₀ + q₂ | 0 | r₂ − r₃ | r₂ − r₃ | a₂₈ | 1 |
| 55 | 0 | 1 | 0 | 0011 | 0010 | 0 | q₃ = x₂₉ | 1 | (q₀ − q₂)W₄⁰ | q₁ | r₁ = q₁ + q₃ | 1 | r₀ | r₀ + r₁ | a₅ | 1 |
| 56 | 0 | 1 | 0 | 0111 | 1010 | 1 | q₀ = x₆ | 0 | (q₁ − q₃)W₄¹ | (q₀ − q₂)W₄⁰ | r₂ = (q₀ − q₂)W₄⁰ | 0 | r₀ − r₁ | r₀ − r₁ | a₂₁ | 1 |
| 57 | 0 | 1 | 0 | 1011 | 0110 | 1 | q₁ = x₁₄ | 0 | q₀ | (q₁ − q₃)W₄¹ | r₃ = (q₁ − q₃)W₄¹ | 1 | r₂ | r₂ + r₃ | a₁₃ | 1 |
| 58 | 0 | 1 | 0 | 1111 | 1110 | 1 | q₂ = x₂₂ | 1 | q₁ | q₀ | r₀ = q₀ + q₂ | 0 | r₂ − r₃ | r₂ − r₃ | a₂₉ | 1 |
| 59 | 0 | 0 | 1 | 0011 | 0011 | 1 | q₃ = x₃₀ | 1 | (q₀ − q₂)W₄⁰ | q₁ | r₁ = q₁ + q₃ | 1 | r₀ | r₀ + r₁ | a₆ | 1 |
| 60 | 0 | 0 | 1 | 1011 | 0111 | 0 | q₀ = x₇ | 0 | (q₁ − q₃)W₄¹ | (q₀ − q₂)W₄⁰ | r₂ = (q₀ − q₂)W₄⁰ | 0 | r₀ − r₁ | r₀ − r₁ | a₂₂ | 1 |
| 61 | 0 | 0 | 1 | 0111 | 1011 | 0 | q₁ = x₁₅ | 0 | q₀ | (q₁ − q₃)W₄¹ | r₃ = (q₁ − q₃)W₄¹ | 1 | r₂ | r₂ + r₃ | a₁₄ | 1 |
| 62 | 0 | 0 | 1 | 1111 | 1111 | 0 | q₂ = x₂₃ | 1 | q₁ | q₀ | r₀ = q₀ + q₂ | 0 | r₂ − r₃ | r₂ − r₃ | a₃₀ | 1 |
| 63 | 0 | 1 | 0 | 0000 | 0011 | 0 | q₃ = x₃₁ | 1 | (q₀ − q₂)W₄⁰ | q₁ | r₁ = q₁ + q₃ | 1 | r₀ | r₀ + r₁ | a₇ | 1 |
| 64 | 0 | 1 | 0 | 0001 | 1011 | 1 | q₀ = a₀ | 0 | (q₁ − q₃)W₄¹ | (q₀ − q₂)W₄⁰ | r₂ = (q₀ − q₂)W₄⁰ | 0 | r₀ − r₁ | r₀ − r₁ | a₂₃ | 1 |
| 65 | 0 | 1 | 0 | 0010 | 0111 | 1 | q₁ = a₂ | 0 | q₀ | (q₁ − q₃)W₄¹ | r₃ = (q₁ − q₃)W₄¹ | 1 | r₂ | r₂ + r₃ | a₁₅ | 1 |
| 66 | 0 | 1 | 0 | 0011 | 1111 | 1 | q₂ = a₄ | 1 | q₁ | q₀ | r₀ = q₀ + q₂ | 0 | r₂ − r₃ | r₂ − r₃ | a₃₁ | 1 |
| 67 | 0 | 0 | 1 | 0000 | 0000 | 1 | q₃ = a₆ | 1 | (q₀ − q₂)W₄⁰ | q₁ | r₁ = q₁ + q₃ | 1 | r₀ | r₀ + r₁ | b₀ | 1 |
| 68 | 0 | 0 | 1 | 0010 | 0001 | 0 | q₀ = a₁ | 0 | (q₁ − q₃)W₄¹ | (q₀ − q₂)W₄⁰ | r₂ = (q₀ − q₂)W₄⁰ | 0 | r₀ − r₁ | r₀ − r₁ | b₄ | 1 |
| 69 | 0 | 0 | 1 | 0001 | 0010 | 0 | q₁ = a₃ | 0 | q₀ | (q₁ − q₃)W₄¹ | r₃ = (q₁ − q₃)W₄¹ | 1 | r₂ | r₂ + r₃ | b₂ | 1 |
| 70 | 0 | 0 | 1 | 0011 | 0011 | 0 | q₂ = a₅ | 1 | q₁ | q₀ | r₀ = q₀ + q₂ | 0 | r₂ − r₃ | r₂ − r₃ | b₆ | 1 |
| 71 | 0 | 1 | 0 | 0100 | 0000 | 0 | q₃ = a₇ | 1 | (q₀ − q₂)W₄⁰ | q₁ | r₁ = q₁ + q₃ | 1 | r₀ | r₀ + r₁ | b₁ | 1 |
| 72 | 0 | 1 | 0 | 0101 | 0010 | 1 | q₀ = a₈ | 0 | (q₁ − q₃)W₄¹ | (q₀ − q₂)W₄⁰ | r₂ = (q₀ − q₂)W₄⁰ | 0 | r₀ − r₁ | r₀ − r₁ | b₅ | 1 |
| 73 | 0 | 1 | 0 | 0110 | 0001 | 1 | q₁ = a₁₀ | 0 | q₀ | (q₁ − q₃)W₄¹ | r₃ = (q₁ − q₃)W₄¹ | 1 | r₂ | r₂ + r₃ | b₃ | 1 |
| 74 | 0 | 1 | 0 | 0111 | 0011 | 1 | q₂ = a₁₂ | 1 | q₁ | q₀ | r₀ = q₀ + q₂ | 0 | r₂ − r₃ | r₂ − r₃ | b₇ | 1 |
| 75 | 0 | 0 | 1 | 0100 | 0100 | 1 | q₃ = a₁₄ | 1 | (q₀ − q₂)W₄⁰ | q₁ | r₁ = q₁ + q₃ | 1 | r₀ | r₀ + r₁ | b₈ | 1 |
| 76 | 0 | 0 | 1 | 0110 | 0101 | 0 | q₀ = a₉ | 0 | (q₁ − q₃)W₄¹ | (q₀ − q₂)W₄⁰ | r₂ = (q₀ − q₂)W₄⁰ | 0 | r₀ − r₁ | r₀ − r₁ | b₁₂ | 1 |
| 77 | 0 | 0 | 1 | 0101 | 0110 | 0 | q₁ = a₁₁ | 0 | q₀ | (q₁ − q₃)W₄¹ | r₃ = (q₁ − q₃)W₄¹ | 1 | r₂ | r₂ + r₃ | b₁₀ | 1 |
| 78 | 0 | 0 | 1 | 0111 | 0111 | 0 | q₂ = a₁₃ | 1 | q₁ | q₀ | r₀ = q₀ + q₂ | 0 | r₂ − r₃ | r₂ − r₃ | b₁₄ | 1 |
| 79 | 0 | 1 | 0 | 1000 | 0100 | 0 | q₃ = a₁₅ | 1 | (q₀ − q₂)W₄⁰ | q₁ | r₁ = q₁ + q₃ | 1 | r₀ | r₀ + r₁ | b₉ | 1 |
| 80 | 0 | 1 | 0 | 1001 | 0110 | 1 | q₀ = a₁₆ | 0 | (q₁ − q₃)W₄¹ | (q₀ − q₂)W₄⁰ | r₂ = (q₀ − q₂)W₄⁰ | 0 | r₀ − r₁ | r₀ − r₁ | b₁₃ | 1 |
| 81 | 0 | 1 | 0 | 1010 | 0101 | 1 | q₁ = a₁₈ | 0 | q₀ | (q₁ − q₃)W₄¹ | r₃ = (q₁ − q₃)W₄¹ | 1 | r₂ | r₂ + r₃ | b₁₁ | 1 |
| 82 | 0 | 1 | 0 | 1011 | 0111 | 1 | q₂ = a₂₀ | 1 | q₁ | q₀ | r₀ = q₀ + q₂ | 0 | r₂ − r₃ | r₂ − r₃ | b₁₅ | 1 |
| 83 | 0 | 0 | 1 | 1000 | 1000 | 1 | q₃ = a₂₂ | 1 | (q₀ − q₂)W₄⁰ | q₁ | r₁ = q₁ + q₃ | 1 | r₀ | r₀ + r₁ | b₁₆ | 1 |
| 84 | 0 | 0 | 1 | 1010 | 1001 | 0 | q₀ = a₁₇ | 0 | (q₁ − q₃)W₄¹ | (q₀ − q₂)W₄⁰ | r₂ = (q₀ − q₂)W₄⁰ | 0 | r₀ − r₁ | r₀ − r₁ | b₂₀ | 1 |
| 85 | 0 | 0 | 1 | 1001 | 1010 | 0 | q₁ = a₁₉ | 0 | q₀ | (q₁ − q₃)W₄¹ | r₃ = (q₁ − q₃)W₄¹ | 1 | r₂ | r₂ + r₃ | b₁₈ | 1 |
| 86 | 0 | 0 | 1 | 1011 | 1011 | 0 | q₂ = a₂₁ | 1 | q₁ | q₀ | r₀ = q₀ + q₂ | 0 | r₂ − r₃ | r₂ − r₃ | b₂₂ | 1 |
| 87 | 0 | 1 | 0 | 1100 | 1000 | 0 | q₃ = a₂₃ | 1 | (q₀ − q₂)W₄⁰ | q₁ | r₁ = q₁ + q₃ | 1 | r₀ | r₀ + r₁ | b₁₇ | 1 |
| 88 | 0 | 1 | 0 | 1101 | 1010 | 1 | q₀ = a₂₄ | 0 | (q₁ − q₃)W₄¹ | (q₀ − q₂)W₄⁰ | r₂ = (q₀ − q₂)W₄⁰ | 0 | r₀ − r₁ | r₀ − r₁ | b₂₁ | 1 |
| 89 | 0 | 1 | 0 | 1110 | 1001 | 1 | q₁ = a₂₆ | 0 | q₀ | (q₁ − q₃)W₄¹ | r₃ = (q₁ − q₃)W₄¹ | 1 | r₂ | r₂ + r₃ | b₁₉ | 1 |
| 90 | 0 | 1 | 0 | 1111 | 1011 | 1 | q₂ = a₂₈ | 1 | q₁ | q₀ | r₀ = q₀ + q₂ | 0 | r₂ − r₃ | r₂ − r₃ | b₂₃ | 1 |
| 91 | 0 | 0 | 1 | 1100 | 1100 | 1 | q₃ = a₃₀ | 1 | (q₀ − q₂)W₄⁰ | q₁ | r₁ = q₁ + q₃ | 1 | r₀ | r₀ + r₁ | b₂₄ | 1 |
| 92 | 0 | 0 | 1 | 1110 | 1101 | 0 | q₀ = a₂₅ | 0 | (q₁ − q₃)W₄¹ | (q₀ − q₂)W₄⁰ | r₂ = (q₀ − q₂)W₄⁰ | 0 | r₀ − r₁ | r₀ − r₁ | b₂₈ | 1 |
| 93 | 0 | 0 | 1 | 1101 | 1110 | 0 | q₁ = a₂₇ | 0 | q₀ | (q₁ − q₃)W₄¹ | r₃ = (q₁ − q₃)W₄¹ | 1 | r₂ | r₂ + r₃ | b₂₆ | 1 |
| 94 | 0 | 0 | 1 | 1111 | 1111 | 0 | q₂ = a₂₉ | 1 | q₁ | q₀ | r₀ = q₀ + q₂ | 0 | r₂ − r₃ | r₂ − r₃ | b₃₀ | 1 |
| 95 | 0 | 1 | x | X | 1100 | 0 | q₃ = a₃₁ | 1 | (q₀ − q₂)W₄⁰ | q₁ | r₁ = q₁ + q₃ | 1 | r₀ | r₀ + r₁ | b₂₅ | 1 |
| 96 | 0 | 1 | x | X | 1110 | x | x | 0 | (q₁ − q₃)W₄¹ | (q₀ − q₂)W₄⁰ | r₂ = (q₀ − q₂)W₄⁰ | 0 | r₀ − r₁ | r₀ − r₁ | b₂₉ | 1 |
| 97 | 0 | 1 | x | X | 1101 | x | x | 0 | x | (q₁ − q₃)W₄¹ | r₃ = (q₁ − q₃)W₄¹ | 1 | r₂ | r₂ + r₃ | b₂₇ | 1 |
| 98 | 0 | 1 | 0 | 0000 | 1111 | x | x | x | x | x | x | 0 | r₂ − r₃ | r₂ − r₃ | b₃₁ | x |
| 99 | 1 | 0 | 1 | 0000 | 0000 | 1 | q₀ = b₀ | x | x | x | r₀ = b₀ | 0 | x | x | x₀ | 0 |
| 100 | 1 | 1 | 0 | 0001 | 0000 | 0 | q₁ = b₁ | x | x | x | r₁ = b₁ | 1 | r₀ | c₀ = r₀ + r₁ | x₁ | 0 |
| 101 | 1 | 0 | 1 | 0001 | 0001 | 1 | q₀ = b₂ | x | x | x | r₀ = b₂ | 0 | r₀ − r₁ | c₁ = r₀ − r₁ | x₂ | 0 |
| 102 | 1 | 1 | 0 | 0010 | 0001 | 0 | q₁ = b₃ | x | x | x | r₁ = b₃ | 1 | r₀ | c₂ = r₀ + r₁ | x₃ | 0 |
| 103 | 1 | 0 | 1 | 0010 | 0010 | 1 | q₀ = b₄ | x | x | x | r₀ = b₄ | 0 | r₀ − r₁ | c₃ = r₀ − r₁ | x₄ | 0 |
| 104 | 1 | 1 | 0 | 0011 | 0010 | 0 | q₁ = b₅ | x | x | x | r₁ = b₅ | 1 | r₀ | c₄ = r₀ + r₁ | x₅ | 0 |
| 105 | 1 | 0 | 1 | 0011 | 0011 | 1 | q₀ = b₆ | x | x | x | r₀ = b₆ | 0 | r₀ − r₁ | c₅ = r₀ − r₁ | x₆ | 0 |
| 106 | 1 | 1 | 0 | 0100 | 0011 | 0 | q₁ = b₇ | x | x | x | r₁ = b₇ | 1 | r₀ | c₆ = r₀ + r₁ | x₇ | 0 |
| 107 | 1 | 0 | 1 | 0100 | 0100 | 1 | q₀ = b₈ | x | x | x | r₀ = b₈ | 1 | r₀ − r₁ | c₇ = r₀ − r₁ | x₈ | 0 |
| 108 | 1 | 1 | 0 | 0101 | 0100 | 0 | q₁ = b₉ | x | x | x | r₁ = b₉ | 0 | r₀ | c₈ = r₀ + r₁ | x₉ | 0 |
| 109 | 1 | 0 | 1 | 0101 | 0101 | 1 | q₀ = b₁₀ | x | x | x | r₀ = b₁₀ | 1 | r₀ − r₁ | c₉ = r₀ − r₁ | x₁₀ | 0 |
| 110 | 1 | 1 | 0 | 0110 | 0101 | 0 | q₁ = b₁₁ | x | x | x | r₁ = b₁₁ | 0 | r₀ | c₁₀ = r₀ + r₁ | x₁₁ | 0 |
| 111 | 1 | 0 | 1 | 0110 | 0110 | 1 | q₀ = b₁₂ | x | x | x | r₀ = b₁₂ | 1 | r₀ − r₁ | c₁₁ = r₀ − r₁ | x₁₂ | 0 |
| 112 | 1 | 1 | 0 | 0111 | 0110 | 0 | q₁ = b₁₃ | x | x | x | r₁ = b₁₃ | 0 | r₀ | c₁₂ = r₀ + r₁ | x₁₃ | 0 |
| 113 | 1 | 0 | 1 | 0111 | 0111 | 1 | q₀ = b₁₄ | x | x | x | r₀ = b₁₄ | 1 | r₀ − r₁ | c₁₃ = r₀ − r₁ | x₁₄ | 0 |
| 114 | 1 | 1 | 0 | 1000 | 0111 | 0 | q₁ = b₁₅ | x | x | x | r₁ = b₁₅ | 1 | r₀ | c₁₄ = r₀ + r₁ | x₁₅ | 0 |
| 115 | 1 | 0 | 1 | 1000 | 1000 | 1 | q₀ = b₁₆ | x | x | x | r₀ = b₁₆ | 0 | r₀ − r₁ | c₁₅ = r₀ − r₁ | x₁₆ | 0 |
| 116 | 1 | 1 | 0 | 1001 | 1000 | 0 | q₁ = b₁₇ | x | x | x | r₁ = b₁₇ | 1 | r₀ | c₁₆ = r₀ + r₁ | x₁₇ | 0 |
| 117 | 1 | 0 | 1 | 1001 | 1001 | 1 | q₀ = b₁₈ | x | x | x | r₀ = b₁₈ | 0 | r₀ − r₁ | c₁₇ = r₀ − r₁ | x₁₈ | 0 |
| 118 | 1 | 1 | 0 | 1010 | 1001 | 0 | q₁ = b₁₉ | x | x | x | r₁ = b₁₉ | 1 | r₀ | c₁₈ = r₀ + r₁ | x₁₉ | 0 |
| 119 | 1 | 0 | 1 | 1010 | 1010 | 1 | q₀ = b₂₀ | x | x | x | r₀ = b₂₀ | 0 | r₀ − r₁ | c₁₉ = r₀ − r₁ | x₂₀ | 0 |
| 120 | 1 | 1 | 0 | 1011 | 1010 | 0 | q₁ = b₂₁ | x | x | x | r₁ = b₂₁ | 1 | r₀ | c₂₀ = r₀ + r₁ | x₂₁ | 0 |
| 121 | 1 | 0 | 1 | 1011 | 1011 | 1 | q₀ = b₂₂ | x | x | x | r₀ = b₂₂ | 1 | r₀ − r₁ | c₂₁ = r₀ − r₁ | x₂₂ | 0 |
| 122 | 1 | 1 | 0 | 1100 | 1011 | 0 | q₁ = b₂₃ | x | x | x | r₁ = b₂₃ | 0 | r₀ | c₂₂ = r₀ + r₁ | x₂₃ | 0 |
| 123 | 1 | 0 | 1 | 1100 | 1100 | 1 | q₀ = b₂₄ | x | x | x | r₀ = b₂₄ | 1 | r₀ − r₁ | c₂₃ = r₀ − r₁ | x₂₄ | 0 |
| 124 | 1 | 1 | 0 | 1101 | 1100 | 0 | q₁ = b₂₅ | x | x | x | r₁ = b₂₅ | 0 | r₀ | c₂₄ = r₀ + r₁ | x₂₅ | 0 |
| 125 | 1 | 0 | 1 | 1101 | 1101 | 1 | q₀ = b₂₆ | x | x | x | r₀ = b₂₆ | 1 | r₀ − r₁ | c₂₅ = r₀ − r₁ | x₂₆ | 0 |
| 126 | 1 | 1 | 0 | 1110 | 1101 | 0 | q₁ = b₂₇ | x | x | x | r₁ = b₂₇ | 0 | r₀ | c₂₆ = r₀ + r₁ | x₂₇ | 0 |
| 127 | 1 | 0 | 1 | 1110 | 1110 | 1 | q₀ = b₂₈ | x | x | x | r₀ = b₂₈ | 1 | r₀ − r₁ | c₂₇ = r₀ − r₁ | x₂₈ | 0 |
| 128 | 1 | 1 | 0 | 1111 | 1110 | 0 | q₁ = b₂₉ | x | x | x | r₁ = b₂₉ | 0 | r₀ | c₂₈ = r₀ + r₁ | x₂₉ | 0 |
| 129 | 1 | 0 | 1 | 1111 | 1111 | 1 | q₀ = b₃₀ | x | x | x | r₀ = b₃₀ | 1 | r₀ − r₁ | c₂₉ = r₀ − r₁ | x₃₀ | 0 |
| 130 | 1 | 1 | 0 | 0000 | 1111 | 0 | q₁ = b₃₁ | x | x | x | r₁ = b₃₁ | 0 | r₀ | c₃₀ = r₀ + r₁ | x₃₁ | 0 |
| 131 | x | 0 | 0 | 0100 | x | 1 | q₀ = x₀ | 0 | x | x | x | 1 | r₀ − r₁ | c₃₁ = r₀ − r₁ | x | 1 |

The aforementioned descriptions discloses the generation of the first control signals A₀, A₁, A₂, A₃, Ad₀, and Ad₁ by the control unit 33, wherein the first control signals are used to control the operations of the first RAM 311 and the second RAM 312. The second control signals B₀ and B₁ respectively control the data flow of the calculation unit P₁(4) and P₂(2). The third control signal C₀ sets the calculation point of DFT. Regardless of the time required by the calculation unit to change the DFT calculation points, the apparatus 3 can finish an N-point DFT with in N×(┌ log_{N1}N┐) clock cycles in average. In the embodiment, N=32 and N₁=4, a 32-point DFT can be finished within 32×(┌ log₄32┐)=96 clock cycles in average. From the viewpoint of the design of the control unit, a (┌ logN₁N┐)+log₂N bit counter can be used to generate all the control signals. According to the aforementioned descriptions, the present invention can be made in a small-sized chip and can achieve the computation of the long-length DFT within an acceptable amount of time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for calculating an N-point Discrete Fourier Transform (DFT) by utilizing Cooley-Tukey algorithm, the N-point DFT being factored into a plurality of N₁-point DFTs and a plurality of N₂-point DFTs, each of N, N₁, and N₂ being a number, the number being a power of two and N₂ being not greater than N₁, the apparatus comprising:
a store unit comprising a first memory for storing a plurality of first data and a second memory for storing a plurality of second data, the store unit being configured to receive a plurality of first control signals to control operations of the first memory and the second memory;
a calculation unit comprising a plurality of P_{N}_{₁}_{/M} (M) calculation units, for computing the N₁-point DFT and the N₂-point DFTs, M being a power of two number, the number ranging from N₁ to two, each of the P_{N}_{₁}_{/M} (M) calculation units being an N₁ by N₁ matrix, being a direct sum of N₁/M P(M) matrixes, and having the form of
$${P}_{{N}_{1} / M} ( M ) = P ( M ) ⊕ … ⊕ P ( M ) = [ \begin{matrix}P ( M ) & 0 & … & 0 \\ 0 & P ( M ) & … & 0 \\ ⋮ & ⋮ & ⋰ & ⋮ \\ 0 & 0 & … & P ( M )\end{matrix} ] , \\ P ( M ) = [ \begin{matrix}{I}_{M / 2} & 0 \\ 0 & F ( M / 2 )\end{matrix} ] [ \begin{matrix}{I}_{M / 2} & {I}_{M / 2} \\ {I}_{M / 2} & - {I}_{M / 2}\end{matrix} ] , \\ F ( M / 2 ) = [ \begin{matrix}{W}_{M}^{0} & 0 & … & 0 \\ 0 & {W}_{M}^{1} & … & 0 \\ ⋮ & ⋮ & ⋰ & ⋮ \\ 0 & 0 & … & {W}_{M}^{M / {2}^{- 1}}\end{matrix} ] ,$$
I_{M/2} being an M/2 by M/2 unit matrix, and W_{M}=e^{-j2π/M}, the calculation unit being configured to receive a plurality of second control signals, a plurality of third control signals, the first data, and the second data, the second control signals being configured to control data flow of the P_{N}_{₁}_{/M} (M) calculation units, the third control signals being configured to set a calculation point for the calculation unit to select the corresponding P_{N}_{₁}_{/M} (M) calculation units for execution and to generate a plurality of output data; and
a control unit for generating the first control signals, the second control signals, and the third control signals.

2. The apparatus of claim 1, wherein the first control signals comprises:
a set of address signals for deciding read and write addresses of the first memory and the second memory;
a set of data selection signals for enabling the store unit to read data from one of a feedback data of the plurality of output data and an input data, for storing the read data as the first data and the second data, and for enabling one of the plurality of first data and the plurality of second data to be outputted to the calculation unit; and
a set of read/write control signals for controlling read and write of the first memory and the second memory.

3. The apparatus of claim 2, wherein the third control signals set the calculation point as N₁ for execution the N₁-point DFT, and a number of clock cycles required by the calculate unit from the receipt of a first piece of the first data or the second data to the output of a first piece of the output data is N₁−1.

4. The apparatus of claim 2, wherein the third control signals set the calculation point as N₂ for executing the N₂-point DFT, and a number of clock cycles required by the calculate unit from the receipt of a first piece of the first data or the second data to the output of a first piece of the output data is N₂−1.

5. The apparatus of claim 2, wherein the set of read/write control signals separately write the first data into the first memory and the second data into the second memory.

6. The apparatus of claim 2, wherein the set of read/write control signals separately read the first data from the first memory and the second data from the second memory.

7. The apparatus of claim 2, wherein the set of read/write control signals changes every N₁ cycles when the third control signals set the calculation point as N₁ for the execution of N₁-point DFT.

8. The apparatus of claim 1, wherein the first memory and the second memory are random access memories.

9. The apparatus of claim 1, wherein the size of both the first memory and the second memory is N/2 units.

10. The apparatus of claim 1, wherein the plurality of P_{N}_{₁}_{/M} (M) calculation units are arranged according to the decreasing arrangement of M.

11. The apparatus of claim 1, wherein part of the address bits of the plurality output data are the reverse permutation of part of the address bits before being calculated by the calculation unit.
